(19) United States
(12) Patent Application Publication
(10) Pub. No.: US 2025/0337053 A1
(43) Pub. Date: Oct. 30, 2025

(54) HEAT INSULATION SHEET FOR RECHARGEABLE LITHIUM BATTERY AND RECHARGEABLE LITHIUM BATTERY MODULE INCLUDING THE SAME

(71) Applicant: SAMSUNG SDI CO., LTD., Yongin-si (KR)

(72) Inventors: Ha Na RA, Suwon-si (KR); Myung Heui WOO, Suwon-si (KR); Seung Yong YANG, Suwon-si (KR); Jung Hyo LEE, Suwon-si (KR); Hye Jin PARK, Suwon-si (KR); Jae Hyun LEE, Suwon-si (KR); Kang Won LEE, Suwon-si (KR); Yun Sung YANG, Suwon-si (KR)

(73) Assignee: SAMSUNG SDI CO., LTD., Yongin-si (KR)

(21) Appl. No.: 19/192,835

(22) Filed: Apr. 29, 2025

(30) Foreign Application Priority Data
Apr. 29, 2024 (KR) 10-2024-0057050

(51) Int. Cl. H01M 10/658; B32B 9/00; B32B 9/04; C08K 3/16; C08K 3/26; C08K 3/28; C08K 7/14; C08K 7/22; C09D 7/61; C09D 175/04; C09J 11/04; C09J 129/04; F16L 59/02; H01M 10/647; H01M 10/6555

(52) U.S. Cl. CPC H01M 10/658; B32B 9/002; B32B 9/04; C09D 7/61; C09D 175/04; C09J 11/04; C09J 129/04; F16L 59/029; H01M 10/647; H01M 10/6555; B32B 2255/26; B32B 2262/101; B32B 2307/304; B32B 2457/10; C08K 3/16; C08K 2003/262; C08K 3/28; C08K 7/14; C08K 7/22; H01M 2220/20

(57) ABSTRACT

The present disclosure relates to a heat insulation sheet for a rechargeable lithium battery, and a rechargeable lithium battery module. A heat insulation sheet for a rechargeable lithium battery includes a base sheet including a first base layer and an aerogel-containing layer that are stacked together, and a member completely surrounding an exterior of the base sheet. The aerogel-containing layer includes a binder including a polyvinyl alcohol-based binder, a fibrous support, and an aerogel, and the member includes one or more of potassium nitrate, potassium carbonate, and potassium perchlorate, and a support.

### CROSS-REFERENCE TO RELATED APPLICATION

The present application claims the benefit of priority to Korean Patent Application No. 10-2024-0057050, filed on Apr. 29, 2024 in the Korean Intellectual Property Office, the entire disclosure of which is incorporated herein by reference.

### BACKGROUND

### 1. Field of the Disclosure

The present disclosure relates to a heat insulation sheet for a rechargeable lithium battery, and a rechargeable lithium battery module including the heat insulation sheet.

### 2. Discussion of Related Art

With increasing presence of electronic devices, such as, e.g., mobile phones, notebook computers, electric vehicles, and the like, using batteries, the demand for secondary batteries having high energy density and high capacity is increasing. Therefore, improving the performance of rechargeable lithium batteries may be advantageous.

A rechargeable lithium battery typically includes a positive electrode and a negative electrode that include an active material capable of the intercalation and deintercalation of lithium ions, and produces electric energy by oxidation and reduction reactions when the lithium ions are intercalated into and deintercalated from the positive electrode and the negative electrode.

A plurality of rechargeable lithium batteries may be included to form a rechargeable lithium battery module. In the rechargeable lithium battery module, reducing or blocking heat propagation and/or heat transfer between adjacent cells may be advantageous.

### SUMMARY

One example embodiment includes a heat insulation sheet for a rechargeable lithium battery with desired or improved heat insulation, flame retardancy, heat propagation delay, and compression properties.

Another example embodiment includes a rechargeable lithium battery module including the heat insulation sheet for a rechargeable lithium battery.

According to one example embodiment, a heat insulation sheet for a rechargeable lithium battery includes a base sheet including a first base layer and an aerogel-containing layer that are stacked, e.g., sequentially stacked, and a member completely surrounding, or substantially completely surrounding, an exterior of the base sheet. The aerogel-containing layer includes a binder including a polyvinyl alcohol-based binder, a fibrous support, and an aerogel. The member includes one or more of potassium nitrate, potassium carbonate, and potassium perchlorate, and a support.

According to another example embodiment, a rechargeable lithium battery module includes a plurality of battery cells that face each other, and the heat insulation sheet for a rechargeable lithium battery between the plurality of battery cells.

### BRIEF DESCRIPTION OF THE DRAWINGS

FIG. 1 is a cross-sectional view of a heat insulation sheet for a rechargeable lithium battery, according to one example embodiment.

FIG. 2 is a cross-sectional view of a heat insulation sheet for a rechargeable lithium battery, according to another example embodiment.

FIG. 3 is a cross-sectional view of a heat insulation sheet for a rechargeable lithium battery, according to still another example embodiment.

FIG. 4 is a perspective view of a rechargeable lithium battery module, according to one example embodiment.

FIG. 5 is an exploded perspective view of the rechargeable lithium battery module, according to one example embodiment.

FIG. 6 is a cross-sectional view schematically illustrating a battery cell, according to one example embodiment.

FIG. 7 is a cross-sectional view schematically illustrating a battery pack, according to one example embodiment.

FIG. 8 is a cross-sectional view schematically illustrating the battery pack, according to one example embodiment.

FIG. 9 is a view illustrating a vehicle body and vehicle body parts, according to one example embodiment.

FIG. 10 is a view illustrating a vehicle body and vehicle body parts, according to one example embodiment.

### DETAILED DESCRIPTION

Hereinafter, example embodiments of the present disclosure are described in detail. However, the embodiments are presented as examples, and the present disclosure is not limited thereto, and the present disclosure is only defined by the scope of the appended claims.

Unless otherwise stated herein, when a part such as a layer, a membrane, an area, a plate, and the like, is described as being disposed “on” another part, it includes not only a case where the part is “directly on” another part, but also a case where there are other parts therebetween.

Unless otherwise stated herein, the singular may also include the plural. In addition, unless otherwise stated, “A or B” may indicate “including A, including B, or including A and B.”

In the present specification, “a combination thereof” may indicate a mixture, stack, composite, copolymer, alloy, blend, and reaction product of constituents.

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

### Heat Insulation Sheet for a Rechargeable Lithium Battery:

A heat insulation sheet for a rechargeable lithium battery according to one example embodiment includes a base sheet including a first base layer and an aerogel-containing layer that are stacked, e.g., sequentially stacked, and a member completely surrounding, or substantially completely surrounding, an exterior of the base sheet. The aerogel-containing layer includes a binder including a polyvinyl alcohol-based binder, a fibrous support, and aerogel. The member includes one or more of potassium nitrate, potassium carbonate, and potassium perchlorate, and a support.

The base sheet according to one example embodiment may further include a second base layer stacked on the aerogel-containing layer. The first base layer and the second base layer may be the same or different.

Hereinafter, the heat insulation sheet according to one example embodiment is described in detail.

### Base Sheet

The base sheet includes a first base layer and an aerogel-containing layer that are stacked, e.g., sequentially stacked.

The base sheet may include the first base layer, the aerogel-containing layer, and a second base layer that are stacked, e.g., sequentially stacked.

### First Base Layer

The first base layer may support the aerogel-containing layer and the second base layer of the heat insulation sheet.

The first base layer may be included in one or more layers, that is, one layer, or two or more layers, in the heat insulation sheet.

The first base layer may be formed of or include a resin, a metal-based inorganic material, inorganic materials other than the metal-based material, or a composite thereof, or may be or include at least one of a film, a thin film, or a sheet including the film or thin film.

The resin may include, for example, one or more of polyolefin-based resins such as polyethylene or polypropylene; polystyrene-based resins; polyester-based resins such as polyethylene terephthalate or polybutylene terephthalate; polyamide-based resins; and polyimide-based resins.

The metal-based inorganic material may include, for example, one or more of copper, nickel, cobalt, iron, chromium, vanadium, palladium, ruthenium, rhodium, molybdenum, tungsten, iridium, silver, gold, and platinum. The metal-based inorganic material may undergo anti-corrosion treatment, insulation treatment, and the like, as needed.

Inorganic materials other than the metal-based material may include one or more of calcium carbonate, talc, mica, glass wool, ceramic wool, carbon fiber, and aramid fiber.

According to one example embodiment, the heat insulation sheet may include inorganic materials other than the metal-based material as the first base layer, and for example include a mica sheet. Mica can be useful in improving the heat insulation and durability of the heat insulation sheet.

The first base layer may have a thickness of about 10 μm to about 5000 μm, for example, 50 μm to 3000 μm or 100 μm to 1000 μm. Within the above range, the first base layer may be included for the heat insulation sheet.

### Aerogel-Containing Layer

The aerogel-containing layer may be or include a separate layer that is independent of the first base layer. Herein, “independent separate layer” indicates that the aerogel-containing layer is not formed through impregnation, and the like, in the base layer, but that the first base layer and the aerogel-containing layer are formed as layers that are completely separated, or substantially completely separated, and noncontinuous.

The aerogel-containing layer may be included in one or more layers, that is, one layer or two or more layers in the heat insulation sheet.

The aerogel-containing layer includes a binder including a polyvinyl alcohol-based binder, a fibrous support, and an aerogel.

The binder includes a polyvinyl alcohol-based binder. The polyvinyl alcohol-based binder is an aqueous binder and may have high solubility in water among solvents to be described below, making it possible to form the aerogel-containing layer. In addition, the polyvinyl alcohol-based binder can readily improve the compression properties of the member, for example when the member is a coating layer. In addition, the polyvinyl alcohol-based binder can allow the aerogel-containing layer to be readily manufactured by binding the fibrous support and the aerogel together, thereby improving processability.

According to one example embodiment, the polyvinyl alcohol-based binder may be included in an amount in a range of about 95 wt % or more of the binder, for example, from 95 to 100 wt % or 100 wt %.

According to another example embodiment, the binder is or includes an organic water-based binder, and may further include one or more of a cationic water-soluble polymer, an anionic water-soluble polymer, and a nonionic water-soluble polymer.

The cationic water-soluble polymer may be or include a polymer having a functional group such as at least one of an amine group, an ammonium group, a phosphonium group, a sulfonium group, or a salt thereof, for example, a polymer having an amine group. For example, the cationic water-soluble polymer may include one or more of polyethyleneamine and polyamine.

The anionic water-soluble polymer may be or include a polymer having a functional group such as at least one of a carboxylic acid group, a sulfonic acid group, an ester group, a phosphoric acid ester group, or a salt thereof, for example, a polymer having a carboxylic acid group. For example, the anionic water-soluble polymer may be or include polymaleic acid.

The nonionic water-soluble polymer may include one or more of polyethylene glycol, polyacrylamide, polyvinylpyrrolidone, polyurethane, and polyester. The nonionic water-soluble polymer may be or include a water-dispersible or water-based polymer.

According to one example embodiment, the binder may include a mixture of one or more of polyvinyl alcohol, polyethylene glycol, polyacrylamide, and polyvinylpyrrolidone, and one or more of polyurethane and polyester. In this case, it may be possible to provide dispersion characteristics by one or more of polyvinyl alcohol, polyethylene glycol, polyacrylamide, and polyvinylpyrrolidone, and fire resistance properties by one or more of polyurethane and polyester. For example, one or more of polyvinyl alcohol and polyurethane may be included.

According to one example embodiment, a weight ratio of one or more of polyvinyl alcohol, polyethylene glycol, polyacrylamide, and polyvinylpyrrolidone to one or more of polyurethane and polyester ranges from about 1:1 to about 1:5, for example, from 1:1 to 1:4 or from 1:2 to 1:3. Within the above range, the heat insulation, dust resistance, fire resistance, and mechanical properties of the heat insulation sheet can be improved.

According to one example embodiment, the binder is or includes an inorganic water-based binder, and may further include one or more of a silicate salt binder of sodium, potassium, or lithium and a phosphate-based binder.

The binder, for example, the polyvinyl alcohol-based binder, may be included in an amount ranging from about 0.5 wt % to about 20 wt % of the aerogel-containing layer. For example, the binder may be included in an amount ranging from 2 wt % to 15 wt %, from 5 wt % to 15 wt %, or from 5 wt % to 10 wt % of the aerogel-containing layer. Within the above range, it is possible to readily improve the compression properties and dust resistance of the heat insulation sheet.

The fibrous support may help support the aerogel-containing layer and improve the compression properties of the heat insulation sheet.

The fibrous support may be or include, for example, at least one of a wool mat or a chopped strand mat.

Fibers constituting the fibrous support may include one or more of natural fibers, glass fibers, carbon fibers, graphite fibers, mineral fibers, and polymer fibers. For example, the compression properties of the fibrous support can be further improved by using glass fibers.

The natural fiber may be or include a fiber made of or including one or more of hemp, jute, flax, coir, kenaf, and cellulose. The mineral fiber may be or include a fiber made of or including one or more of basalt, wollastonite, alumina, silica, slag, and rock. The polymer fiber may be or include a fiber made of or including one or more of nylons, polyimides, polyamides, polybenzimidazoles, polybenzoxazoles, polyamide-imides, polyesters such as polyethylene terephthalate and polybutylene terephthalate, polyolefins such as polyethylene and polypropylene, and basalts.

For example, the fibrous support may be or include glass wool.

The fibers in the fibrous support may have an aspect ratio of about 1 or more, for example, 1 to 20,000 or 2.5 to 10,000. Within the above range, the aerogel-containing layer can be firmly formed, and the durability of the heat insulation sheet can be improved. Herein, “aspect ratio” is a ratio of a length of the fiber to a diameter of the fiber in the fibrous support.

The fibers in the fibrous support may have a length ranging from about 50 μm to about 2000 μm, for example, 50 μm to 1000 μm. Within the above range, the aerogel-containing layer can be firmly formed, and the durability of the heat insulation sheet can be improved.

The fibers in the fibrous support may have a diameter ranging from about 0.1 μm to about 20 μm, for example, from 0.1 μm to 15 μm, from 0.1 μm to 5 μm, from 1 μm to 15 μm, or from 3 μm to 10 μm. Within the above range, the aerogel-containing layer can be firmly formed, and the durability of the heat insulation sheet can be improved. Herein, “diameter” may indicate a diameter when a cross section of the fiber is circular, and may indicate the longest diameter when the above cross section is not circular.

The fibrous support may be included in an amount ranging from about 5 wt % to about 70 wt % of the aerogel-containing layer. For example, the fibrous support may be included in an amount ranging from 10 wt % to 60 wt %, from 10 wt % to 70 wt %, from 10 wt % to 50 wt %, from 25 wt % to 50 wt %, or from 35 wt % to 50 wt % of the aerogel-containing layer. Within the above range, it is possible to readily improve the flexibility and durability of the heat insulation sheet.

The aerogel may provide the heat insulating effect to the aerogel-containing layer.

According to one example embodiment, the aerogel may have a specific surface area ranging from about 500 m²/g to about 1000 m²/g. For example, the specific surface area may range from 500 m²/g to 950 m²/g, 550 m²/g to 950 m²/g, or 600 m²/g to 900 m²/g. Within the above range, it is possible to readily reduce or prevent heat transfer and heat propagation between a plurality of battery cells. Herein, “specific surface area” may be a specific surface area based on Brunauer Emmett Teller (BET) specific surface area analysis.

According to one example embodiment, the aerogel may have an average particle diameter ranging from about 5 μm to about 200 μm. For example, the aerogel may have an average particle diameter ranging from 10 μm to 100 μm or from 20 μm to 50 μm. Within the above range, heat transfer between a plurality of battery cells may be readily delayed by improving the heat insulation properties of the heat insulation sheet. Herein, “average particle diameter” indicates an average particle diameter D50, which refers to a diameter of a particle with a cumulative volume of 50% by volume in the particle size distribution. The average particle diameter D50 may be measured by methods known to those skilled in the art, for example, measured using a particle size analyzer or measured using a transmission electron micrograph or a scanning electron micrograph. As another method, the particle size distribution may be measured using a measurement device using dynamic light scattering, and an average particle diameter D50 value may be obtained by performing data analysis, counting the number of particles in each particle size range, and then calculating the D100 value therefrom. Alternatively, the particle size distribution may be measured using a laser diffraction method. When measuring the average particle diameter by the laser diffraction method, for example, the average particle diameter D50 based on 50% of a particle diameter distribution in the measuring device may be calculated by dispersing particles to be measured in a dispersion medium, then introducing the dispersion medium into a commercially available laser diffraction particle diameter measuring device (e.g., Microtrac's MT 3000), and radiating ultrasonic waves of about 28 kHz at output power of 60 W.

According to one example embodiment, the aerogel may be hydrophobically treated. Herein, an aerogel that has not been hydrophobically treated may be vulnerable to moisture, in the process, moisture is evaporated after slurrying to obtain a heat insulation sheet, but it takes some time for moisture to evaporate and increases the possibility of cracks occurring in the heat insulation sheet. Even after the heat insulation sheet is manufactured, there is a substantial possibility of absorbing moisture, which can lower reliability. The hydrophobic treatment may be performed on an aerogel that has not been surface-treated using conventional methods known to those skilled in the art.

The aerogel may be included in an amount ranging from about 10 wt % to about 90 wt % of the aerogel-containing layer. For example, the aerogel may be included in an amount ranging from 30 wt % to 70 wt %, from 45 wt % to 65 wt %, from 40 wt % to 60 wt %, or from 40 wt % to 50 wt % of the aerogel-containing layer. Within the above range, the heat insulation properties of the heat insulation sheet can be increased.

According to one example embodiment, a total of the binder including the polyvinyl alcohol-based binder, the fibrous support, and the aerogel may be about 95 wt % or more of the aerogel-containing layer, for example, may range from 95 wt % to 100 wt % or from 99 wt % to 100 wt %, or 100 wt %.

The aerogel-containing layer may further include one or more of a dispersant and a silane-based compound.

The dispersant can improve the dispersion of the aerogel in the composition for the aerogel-containing layer, thereby enabling the manufacturing of the aerogel-containing layer in which the fibrous support and the aerogel are substantially uniformly dispersed.

The dispersant may include one or more of a surfactant and a phosphorus salt. The surfactant may include one or more of a nonionic surfactant, anionic surfactant, and zwitterionic surfactant. The surfactant may include one or more of natural surfactants such as lecithin and non-natural surfactants such as chemicals. The phosphorus salt may be a phosphate-based salt.

The aerogel may be included in an amount ranging from about 0.1 wt % to about 6 wt % of the aerogel-containing layer. For example, the dispersant may be included in an amount ranging from 0.1 wt % to 5 wt % or from 0.1 wt % to 3 wt %. Within the above range, it is possible to prepare a composition for an aerogel-containing layer at low cost and provide a heat insulation sheet with further improved heat insulation, durability, and dust resistance.

According to one example embodiment, the binder:dispersant weight ratio may range from about 1:0.001 to about 1:0.7, for example, from 1:0.001 to 1:0.67, from 1:0.001 to 1:0.5, or from 1:0.001 to 1:0.3. Within the above range, when the binder and the dispersant are included together, it is possible to manufacture an aerogel-containing layer in which the aerogel is further substantially uniformly dispersed.

The silane-based compound can improve the dispersibility of the aerogel in the aerogel-containing layer.

According to one example embodiment, the silane-based compound may include one or more of alkyl group-containing trialkoxysilanes such as methyltrimethoxysilane, methyltriethoxysilane, ethyltrimethoxysilane, ethyltriethoxysilane, or octadecyltrimethoxysilane, epoxy group-containing trialkoxysilanes such as glycidoxypropyltrimethoxysilane, and unsaturated group-containing trialkoxysilanes such as 3-(trimethoxysilyl) propyl methacrylate.

The aerogel-containing layer may further include typical additives known to those skilled in the art. The additives include one or more of wetting agents, emulsifiers, compatibilizers, viscosity regulators, pH regulators, stabilizers, antioxidants, acidic or basic trapping agents, metal deactivators, antifoaming agents, antistatic agents, thickeners, adhesion improvers, binders, flame retardants, impact modifiers, pigments, dyes, colorants, and deodorants.

According to one example embodiment, the aerogel-containing layer may have a thickness ranging from about 100 μm to about 10,000 μm, for example, from 500 μm to 5000 μm or from 1,000 μm to 3,000 μm. Within the above range, the aerogel-containing layer may be included for the heat insulation sheet.

The aerogel-containing layer may be formed using the composition for an aerogel-containing layer including the fibrous support, the aerogel, and the binder. The composition for an aerogel-containing layer may further include one or more of the dispersant, the silane-based compound, and the additive.

A method of manufacturing the aerogel-containing layer is described in detail below.

### Second Base Layer

The second base layer may support the first base layer and the aerogel-containing layer of the heat insulation sheet.

The second base layer may be included in one or more layers, that is, one layer or two or more layers in the heat insulation sheet.

The second base layer may be stacked on the aerogel-containing layer. The aerogel-containing layer may be a separate layer that is independent of the second base layer. Herein, “independent separate layer” indicates that the aerogel-containing layer is not formed through impregnation, and the like, in the second base layer, but that the second base layer and the aerogel-containing layer are formed as layers that are completely separated, or substantially completely separated, and noncontinuous.

The second base layer may be formed of or include at least one of resin, a metal-based inorganic material, inorganic materials other than the metal-based material, or a composite thereof, or may be or include at least one of a film, a thin film, or a sheet including the film or thin film. The resin, the metal-based inorganic material, and the inorganic materials other than the metal-based material are substantially the same as the resin, the metal-based inorganic material, and the inorganic materials described for the first base layer.

According to one example embodiment, the heat insulation sheet may include inorganic materials other than the metal-based material as the second base layer, and for example include a mica sheet. Mica can improve the heat insulation and durability of the heat insulation sheet.

The second base layer may have a thickness ranging from about 10 μm to about 5000 μm, for example, from 50 μm to 3000 μm or from 100 μm to 1000 μm. Within the above range, the second base layer may be included in the heat insulation sheet.

### Member

The member completely surrounds, or substantially completely surrounds, an exterior of the base sheet. The member may be completely in contact with, partially in contact with, or not in contact with, the base sheet.

The member may be in the form of a coating layer, a film, or a sheet. This is described in detail below.

The member includes one or more of potassium nitrate, potassium carbonate, and potassium perchlorate, and a support.

The one or more of the potassium nitrate, potassium carbonate, and potassium perchlorate exhibit the flame retardancy and heat propagation delay effects of the heat insulation sheet. This can hinder or prevent the battery from catching on fire in case of a fire, and delay heat propagation when a spark occurs due to thermal runaway in an adjacent cell, thereby increasing the safety of the battery.

The one or more of potassium nitrate, potassium carbonate, and potassium perchlorate may be included in an amount ranging from about 0.1 wt % to about 50 wt %, for example, from 0.5 wt % to 30 wt % or from 5 wt % to 15 wt % of the member. Within the above range, it is possible to provide the flame retardancy and heat propagation delay effects, and hinder or prevent the one or more of potassium nitrate, potassium carbonate, and potassium perchlorate from scattering from the member.

The one or more of potassium nitrate, potassium carbonate, and potassium perchlorate are solid phases and may be spherical, amorphous, plate-shaped, cubic, and the like, in addition to having a true substantially spherical shape.

The one or more of potassium nitrate, potassium carbonate, and potassium perchlorate may have an average particle diameter ranging from about 0.005 μm to about 10 μm, for example, from 0.01 μm to 1 μm. Within the above range, a coating layer may be readily formed.

The support may allow the one or more of potassium nitrate, potassium carbonate, and potassium perchlorate to be stably maintained in the member. In addition, when the member is a coating layer, the support may allow the coating layer to be fixed and maintained on the base sheet with substantial reliability. For example, the support can facilitate handleability when the member is a film or sheet.

The support may be included in an amount ranging from about 50 wt % to about 99.9 wt %, for example, from 70 wt % to 99.5 wt % or from 85 wt % to 95 wt % of the coating layer. Within the above range, the one or more of potassium nitrate, potassium carbonate, and potassium perchlorate may be hindered or prevented from scattering from the member.

According to one example embodiment, the support may include a binder. The binder may include one or more of an aqueous binder and an organic binder as long as the binder does not affect the above-described effects of the heat insulation sheet. The binder may allow a member in the form of a coating layer to be readily formed.

In one example embodiment, the binder may include a water-dispersible binder. The water-dispersible binder can provide the effect of allowing a slurry for forming the member to be readily prepared.

In one example embodiment, the binder may include one or more of polyvinyl alcohol, polyethylene glycol, polyacrylamide, polyvinylpyrrolidone, polyurethane, and polyimide. For example, the binder may be or include a water-dispersible polyurethane-based binder. The water-dispersible polyurethane-based binder may allow a coating layer including the one or more of potassium nitrate, potassium carbonate, and potassium perchlorate to be readily formed and can also help to improve compression properties.

The binder may be included in an amount ranging from about 50 wt % to about 99.9 wt %, for example, from 70 wt % to 99.5 wt % or from 85 wt % to 95 wt % of the coating layer. Within the above range, it is possible to hinder or prevent the one or more of potassium nitrate, potassium carbonate, and potassium perchlorate from scattering from the coating layer.

According to another example embodiment, the support is a base resin and may include polyolefin-based resins such as a fiber reinforced polymer, high-density polyethylene (HDPE), linear low-density polyethylene (LLDPE), and low-density polyethylene (LDPE), and polyester-based resins such as polyethylene terephthalate and polybutylene terephthalate.

According to one example embodiment, the member may be or include the coating layer.

The coating layer is in contact with the base sheet and completely surrounds, or substantially completely surrounds, an outer surface of the base sheet.

For example, the coating layer may be formed on all, or substantially all, of an upper surface of the base sheet, a lower surface facing the upper surface, and side surfaces connecting the upper surface to the lower surface. Therefore, the coating layer can readily improve the compression properties of the heat insulation sheet. When the coating layer is formed only on the upper and lower surfaces, or on both side surfaces, of the base sheet, the compression properties of the heat insulation sheet may be poor.

According to one example embodiment, the coating layer may be formed directly on the base sheet. Herein, “directly formed” indicates that no adhesive layer, bonding layer, and the like, is formed between the base sheet and the coating layer.

The coating layer includes the one or more of potassium nitrate, potassium carbonate, and potassium perchlorate, and the binder. The one or more of potassium nitrate, potassium carbonate, and potassium perchlorate may be included in an amount ranging from about 0.1 wt % to about 50 wt %, for example, from 0.5 wt % to 30 wt % or from 5 wt % to 15 wt % of the coating layer, and the binder may be included in an amount ranging from about 50 wt % to about 99.9 wt %, for example, from 70 wt % to 99.5 wt % or from 85 wt % to 95 wt % of the coating layer. Within the above range, it is possible to hinder or prevent the one or more of potassium nitrate, potassium carbonate, and potassium perchlorate from scattering from the coating layer.

The coating layer may have a thickness ranging from about 1 μm to about 1000 μm, for example, from 10 μm to 500 μm or from 30 μm to 200 μm. Within the above range, the coating layer may be included for the heat insulation sheet and the battery module.

According to another example embodiment, the member may be or include a film or sheet.

The film or the sheet is in contact, or not in contact, with the base sheet and completely surrounds, or substantially completely surrounds, the outer surface of the base sheet. The film or the sheet may be configured to package the base sheet, thereby improving flame retardant effects and handleability.

The film or the sheet may include the one or more of potassium nitrate, potassium carbonate, and potassium perchlorate, and the base resin. The one or more of potassium nitrate, potassium carbonate, and potassium perchlorate may be included in an amount ranging from about 0.1 wt % to about 50 wt %, for example, from 0.5 wt % to 30 wt % or from 5 wt % to 15 wt % of the film or the sheet, and the binder may be included in an amount ranging from about 50 wt % to about 99.9 wt %, for example, from 70 wt % to 99.5 wt % or from 85 wt % to 95 wt % of the film or the sheet. Within the above range, it is possible to hinder or prevent the one or more of potassium nitrate, potassium carbonate, and potassium perchlorate from scattering from the member and readily implement the packaging function of the base sheet.

The film or the sheet may have a thickness ranging from about 1 μm to about 1000 μm, for example, from 10 μm to 500 μm or from 30 μm to 200 μm. Within the above range, the film or the sheet may be included for the heat insulation sheet and the battery module.

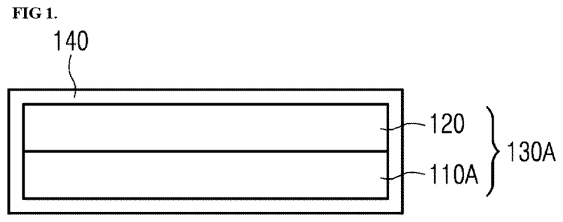

FIGS. 1 to 3 are cross-sectional views of a heat insulation sheet for a rechargeable lithium battery, according to one example embodiment.

Referring to FIG. 1, the heat insulation sheet for a rechargeable lithium battery may include a base sheet 130A including a first base layer 110A, an aerogel-containing layer 120 on the first base layer 110A, and a coating layer 140 completely or substantially entirely surrounding an outer surface of the base sheet 130A.

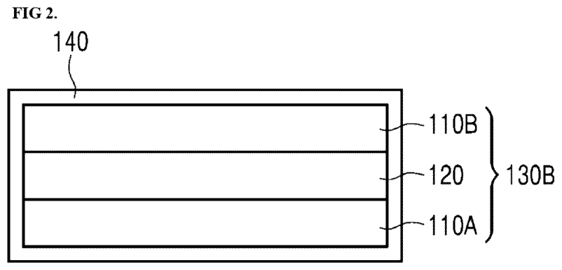

Referring to FIG. 2, the heat insulation sheet for a rechargeable lithium battery may include a base sheet 130B including a first base layer 110A, a second base layer 110B facing the first base layer 110A, an aerogel-containing layer 120 stacked between the first base layer 110A and the second base layer 110B, and a coating layer 140 completely or substantially entirely surrounding an outer surface of the base sheet 130B.

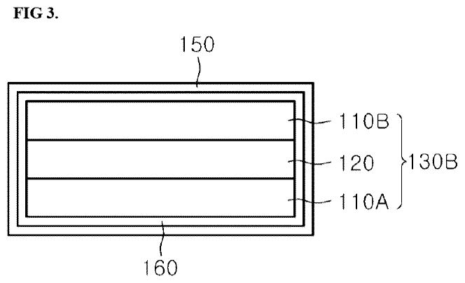

Referring to FIG. 3, the heat insulation sheet for a rechargeable lithium battery may include a base sheet 130B including a first base layer 110A, a second base layer 110B facing the first base layer 110A, an aerogel-containing layer 120 stacked between the first base layer 110A and the second base layer 110B, and a film or sheet 150 completely or substantially entirely surrounding the outer surface of the base sheet 130B. An empty space 160 may be present, or not present, between the base sheet 130B and the film or sheet 150.

Hereinafter, a method of manufacturing the heat insulation sheet according to one example embodiment is described.

According to one example embodiment, the method of manufacturing the heat insulation sheet may include preparing a composition for an aerogel-containing layer including a fibrous support, aerogel, and a binder, manufacturing a base sheet by coating a first base layer with the composition for an aerogel-containing layer and drying the composition for an aerogel-containing layer coated on the first base layer, and forming a coating layer on an outer surface of the base sheet.

According to another example embodiment, the method of manufacturing the heat insulation sheet may include preparing a composition for an aerogel-containing layer including a fibrous support, an aerogel, and a binder, manufacturing a base sheet by coating a first base layer with the composition for an aerogel-containing layer and drying the composition for an aerogel-containing layer coated on the first base layer, and packaging the base sheet with a film or sheet.

The composition for an aerogel-containing layer includes a fibrous support, an aerogel, and a binder. The fibrous support, the aerogel, and the binder are substantially the same as described above.

The composition for an aerogel-containing layer may further include one or more of the dispersant, the silane-based compound, and the additive.

The composition for an aerogel-containing layer may further include a solvent. The solvent may include one or more of a polar solvent and a non-polar solvent.

The polar solvent may include at least one of water, an alcohol-based solvent, or a combination thereof. The water may include, for example, purified water, ultrapure water, or a combination thereof. The alcohol-based solvent may include, for example, one or more of methanol, ethanol, propanol, pentanol, butanol, hexanol, ethylene glycol, propylene glycol, diethylene glycol, and glycerol.

The non-polar solvent may include a hydrocarbon-based solvent. For example, the hydrocarbon-based solvent may include one or more of aliphatic hydrocarbon solvents such as hexane, pentane, and heptane, for example, alkane solvents and aromatic hydrocarbon solvents such as toluene and benzene.

For example, the solvent may include water. When water is included as a solvent, raw material costs and post-treatment costs can be effectively reduced.

The solvent may be included so that a weight ratio of the solvent and a total solid content of the composition for an aerogel-containing layer ranges from about 1:1 to about 1:90. For example, the solvent:total solid content weight ratio of the composition for an aerogel-containing layer may range from 1:50 to 1:70, from 1:20 to 1:30, or from 1:2 to 1:10. Within the above range, the composition for an aerogel-containing layer may be coated by controlling the viscosity of the composition for an aerogel-containing layer.

The composition for an aerogel-containing layer may be prepared using the solvent, the fibrous support, the aerogel, and the binder.

According to one example embodiment, preparing the composition for an aerogel-containing layer may include preparing a first mixed solution by mixing the binder with the solvent, preparing a second mixed solution by mixing an aerogel with the first mixed solution, and preparing the composition for the aerogel-containing layer by mixing the fibrous support with the second mixed solution. During the preparation of the first mixed solution, the dispersant, the silane-based compound, the additive, and the like, may be additionally mixed.

The mixing in each of the preparing the first mixed solution, the preparing the second mixed solution, and the preparing the composition for the aerogel-containing layer, may be performed using a mixer. Examples of the mixer may include a planetary mixer, a Thinky mixer, and the like.

The planetary mixer may include one or more types of planetary blades and one or more types of high-speed dispersion blades. The planetary blade and the high-speed dispersion blade rotate continuously about their axes. A rotational speed may be expressed in revolutions per minute (rpm).

According to one example embodiment, the planetary mixer may include a first blade and a second blade that have different rotational axes. For example, the first blade may be a low-speed blade, and the second blade may be a high-speed blade. Herein, low speed and high speed are relative rotational speeds. For example, the first blade may be an open blade, and the second blade may be a despa blade. A rotational speed of the first blade may range from, for example, about 10 rpm to about 100 rpm or from 10 rpm to 60 rpm. A rotational speed of the second blade may range from 100 rpm to 2000 rpm.

According to one example embodiment, before performing the drying, a second base layer may be additionally stacked on the applied composition for an aerogel-containing layer.

The aerogel-containing layer may be prepared by applying the composition for an aerogel-containing layer, and then drying the composition. The drying may be performed at a temperature ranging from about 25° C. to about 100° C., from 45° C. to 90° C., or from 60° C. to 85° C. Within the above range, an aerogel-containing layer with desired or improved mechanical strength may be formed without a separate adhesive member or an adhesive while reducing or preventing peeling between the first base layer and the aerogel-containing layer and between the aerogel-containing layer and the second base layer.

The coating layer may be manufactured by applying the slurry for a coating layer to the entire surface of the base sheet through coating, spraying, and the like, and drying the slurry.

The slurry may further include an aqueous solvent or an organic solvent to allow the inorganic layer to be substantially uniformly formed.

The drying may be performed at a temperature ranging from about 25° C. to about 100° C., from 45° C. to 90° C., and from 60° C. to 85° C. Within the above range, an aerogel-containing layer with desired or improved mechanical strength may be formed without a separate adhesive member or adhesive while reducing or preventing peeling between the base sheet and the inorganic layer.

### Rechargeable Lithium Battery:

Another example embodiment includes a rechargeable lithium battery module including a plurality of battery cells that face each other, and heat insulating sheets between the plurality of battery cells.

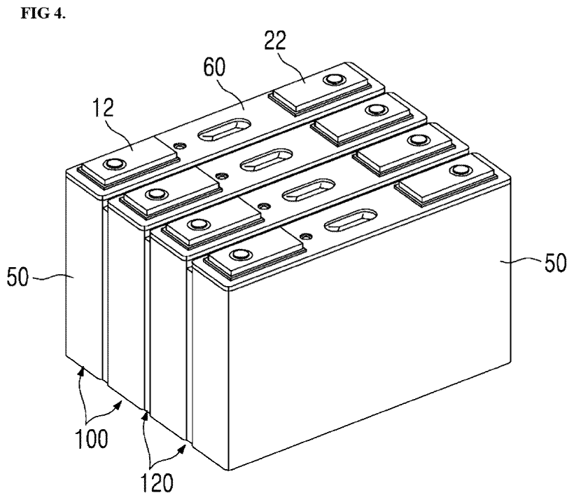

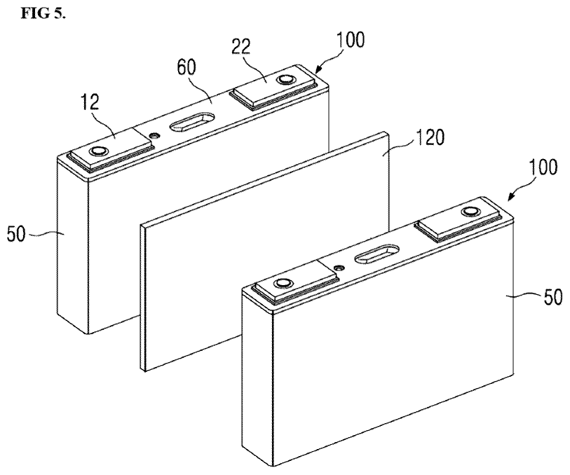

FIGS. 4 and 5 are a perspective view and an exploded perspective view, respectively, of a rechargeable lithium battery module, according to one example embodiment.

Referring to FIGS. 4 and 5, a rechargeable lithium battery module may include a plurality of battery cells 100 that face each other, and heat insulating sheets 200 between the battery cells 100.

The heat insulating sheet 200 for a rechargeable lithium battery may have a plate shape. One surface of the heat insulating sheet 200 may come in contact with one surface of one battery cell 100, and the other surface of the heat insulating sheet 200 opposite to the one surface thereof may come in contact with one surface of another battery cell 100.

The battery cell 100 may include a case 50 configured to accommodate an electrode assembly including a positive electrode and a negative electrode, a cap plate 60 coupled to the case 50 to seal the case 50, and a positive electrode terminal 12 and a negative electrode terminal 22 electrically connected to the positive electrode and the negative electrode of the electrode assembly and protruding to the outside of the cap plate 60.

The positive electrode may include a current collector and a positive electrode active material layer on the current collector. The positive electrode active material layer may include a positive electrode active material, and may further include a binder and/or a conductive additive.

The content of the positive electrode active material may range from about 90 wt % to about 99.5 wt % with respect to 100 wt % of the positive electrode active material layer, and the content of the binder and the content of the conductive additive may each be about 0.5 wt % to about 5 wt % with respect to 100 wt % of the positive electrode active material layer.

Al may be included as the current collector, but the current collector is not limited thereto.

As the positive electrode active material, a compound capable of reversible intercalation and deintercalation of lithium (a lithiated intercalation compound) may be included. For example, one or more of composite oxides of lithium and a metal such as or including at least one of cobalt, manganese, nickel and a combination thereof may be included.

The composite oxides may be or include lithium transition metal composite oxides. Examples of the composite oxides may include at least one of lithium nickel oxide, lithium cobalt oxide, lithium manganese oxide, a lithium iron phosphate compound, cobalt-free nickel-manganese oxide, or a combination thereof.

As one example, a compound represented by any one of the following chemical formulas may be included as the composite oxide. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The negative electrode includes a current collector and a negative electrode active material layer located on the current collector. The negative electrode active material layer may include a negative electrode active material, and further include a binder and/or a conductive additive.

For example, the negative electrode active material layer may include about 90 wt % to about 99 wt % of the negative electrode active material, about 0.5 wt % to about 5 wt % of the binder, and about 0 wt % to about 5 wt % of the conductive additive.

The negative electrode active material includes at least one of a material capable of reversible intercalation/deintercalation of lithium ions, lithium metal, a lithium metal alloy, a material capable of doping and dedoping lithium, or a transition metal oxide.

The material capable of reversible intercalation/deintercalation of lithium ions is a carbon-based negative electrode active material, and may include, for example, at least one of crystalline carbon, amorphous carbon, or a combination thereof. Examples of the crystalline carbon may include graphite such as natural graphite or artificial graphite, and examples of the amorphous carbon may include at least one of soft carbon, hard carbon, mesophase pitch carbide, and calcinated coke.

At least one of a Si-based negative electrode active material or a Sn-based negative electrode active material may be included as the material capable of doping and dedoping lithium. The Si-based negative electrode active material may be or include at least one of silicon, a silicon-carbon composite, SiOₓ (0<x<2), a Si-based alloy, or a combination thereof.

The silicon-carbon composite may be or include a composite of silicon and amorphous carbon. According to one example embodiment, the silicon-carbon composite may have a form including a silicon particle and amorphous carbon coated on a surface of the silicon particle.

The silicon-carbon composite may further include crystalline carbon. For example, the silicon-carbon composite may include a core including crystalline carbon and a silicon particle, and an amorphous carbon coating layer located on a surface of the core.

A nonaqueous binder, an aqueous binder, a dry binder, or a combination thereof may be included as the binder. When the aqueous binder is included as the negative electrode binder, a cellulose-based compound that can impart viscosity may be further included.

As the negative electrode current collector, at least one of copper foil, nickel foil, stainless steel foil, titanium foil, nickel foam, copper foam, a polymer substrate having a conductive metal coated thereon, or combinations thereof may be included.

An electrolyte for a rechargeable lithium battery includes a nonaqueous organic solvent and a lithium salt.

The nonaqueous organic solvent is configured as a medium through which ions involved in an electrochemical reaction of a battery can move.

The nonaqueous organic solvent may be or include at least one of a carbonate-based, ester-based, ether-based, ketone-based, or alcohol-based solvent, an aprotic solvent, or a combination thereof. Any of the above may be included alone as the nonaqueous organic solvent, or two or more of the above may be mixed and included as the nonaqueous organic solvent.

For example, when the carbonate-based solvent is included, a cyclic carbonate and a chain carbonate may be mixed.

A separator may be present between a positive electrode and a negative electrode according to the type of rechargeable lithium battery. At least one of polyethylene, polypropylene, polyvinylidene fluoride, or a multi-layer film of two or more thereof, may be included as the separator.

The separator may include a porous base and a coating layer on one surface, or on both surfaces, of the porous base and including an organic material, an inorganic material, or a combination thereof.

The organic material may include at least one of a polyvinylidene fluoride-based polymer or a (meth)acryl-based polymer.

The inorganic material may include an inorganic particle such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and inorganic material may be mixed in a single coating layer, or may be in a form in which a coating layer including the organic material and a coating layer including the inorganic material are stacked together.

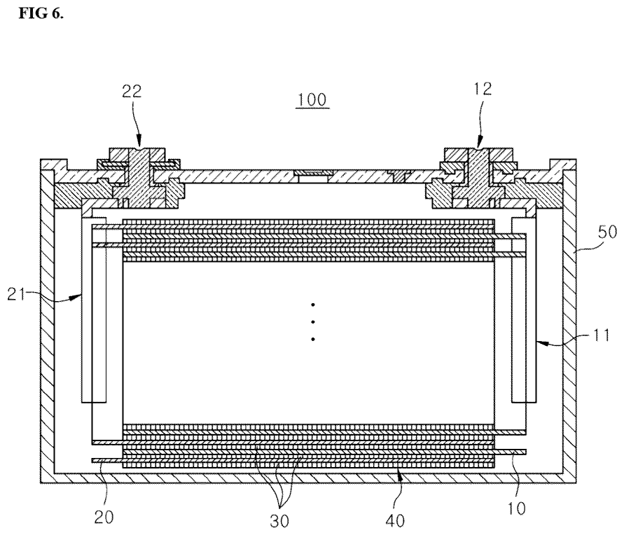

FIG. 6 is a cross-sectional view schematically illustrating the battery cell 100 according to one example embodiment.

Referring to FIG. 6, the battery cell 100 may include an electrode assembly 40 including a positive electrode 10, a negative electrode 20, and a separator 30 interposed between the positive electrode 10 and the negative electrode 20, a case 50 in which the electrode assembly 40 is accommodated, a positive electrode lead tab 11 connected to the positive electrode 10, a positive electrode terminal 12 connected to the positive electrode lead tab 11, a negative electrode lead tab 21 connected to the negative electrode 20, and a negative electrode terminal 22 connected to the negative electrode lead tab 21.

The rechargeable lithium battery module according to one example embodiment may be applicable to, e.g., vehicles, mobile phones, and/or various other forms of electric devices, but the present disclosure is not limited thereto.

The battery module according to the above-described example embodiment may be included in manufacturing a battery pack.

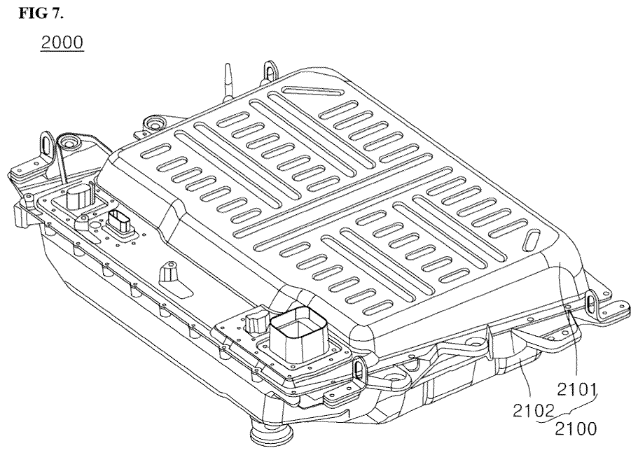

FIG. 7 is a view illustrating a battery pack according to one example embodiment.

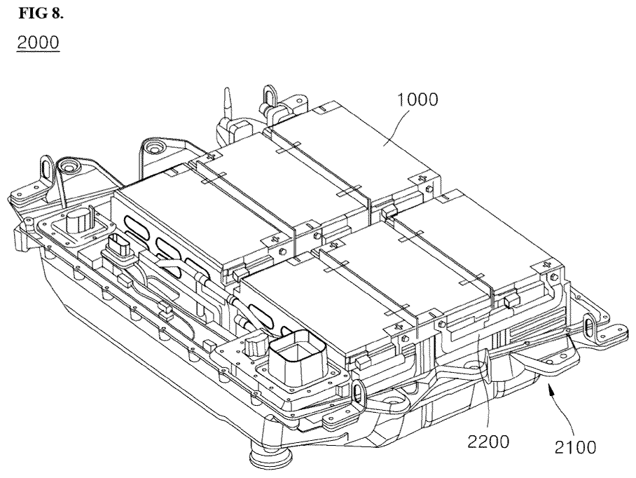

FIG. 8 is a view illustrating a battery pack according to one example embodiment.

A battery pack 2000 according to one example embodiment includes an assembly of electrically connected individual batteries, and a pack case accommodating the batteries. In the drawings, for convenience of illustration of the drawings, illustration of components such as a busbar, a cooling unit, an external terminal, and the like for electrical connection of batteries has been omitted.

For example, the battery pack 2000 may include a plurality of battery modules 1000 (for example, including the battery module described above with reference to FIG. 5) and a pack case 2100 for accommodating the battery modules 1000. For example, the pack case 2100 may include first and second pack cases 2101 and 2102 coupled to each other in directions facing each other while the plurality of battery modules 1000 are interposed therebetween. The plurality of battery modules 1000 may be electrically connected to each other using a busbar 2200, or the plurality of battery modules 1000 may be electrically connected to each other in series or in parallel, or by a combination of serial and parallel connections to obtain a required electrical output.

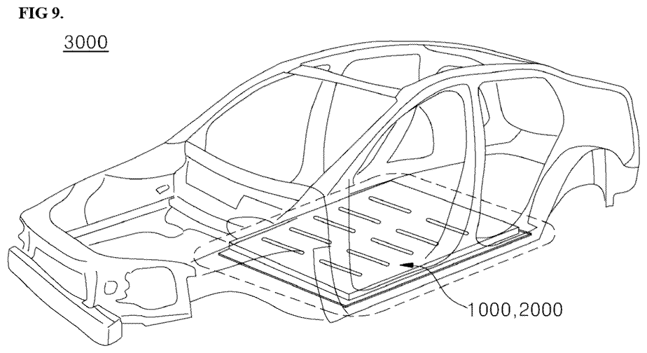

FIG. 9 is a view illustrating a vehicle body and vehicle body components, according to one example embodiment.

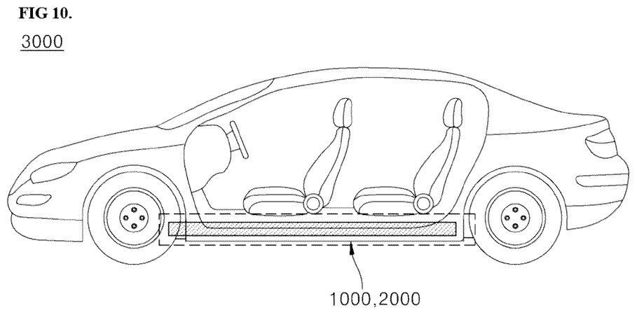

FIG. 10 is a view illustrating a vehicle body and vehicle body components, according to one example embodiment.

The battery pack 2000 according to one example embodiment described above with reference to FIGS. 7 and 8 may be mounted in a vehicle 3000. For example, the vehicle 3000 may be an electric vehicle, a hybrid vehicle, or a plug-in hybrid vehicle. The vehicle may be, e.g., a four-wheel vehicle or a two-wheel vehicle, or another type of vehicle.

As illustrated in FIGS. 9 and 10, the vehicle 3000 according to one example embodiment of the present disclosure includes the battery modules 1000 and/or the battery pack 2000 including the battery modules 1000. The vehicle 3000 operates by receiving power from the battery modules 1000 and/or the battery pack 2000 including the battery modules 1000 according to one example embodiment of the present disclosure.

Hereinafter, examples and comparative examples of the present disclosure are described. However, the following examples are merely embodiments of the present disclosure, and the present disclosure is not limited to the following examples.

### Example 1

### Preparation of Composition for Aerogel-Containing Layer

A first mixed solution was prepared by adding polyvinyl alcohol (Sigma Aldrich, PVA) as a binder to ultrapure water as a solvent and sequentially mixing the first mixed solution at 30 rpm with an open blade and 700 rpm with a despa blade. A second mixed solution was prepared by adding an aerogel (BET specific surface area: 800 m²/g) to the first mixed solution and sequentially mixing the second mixed solution at 70 rpm with the open blade and 1500 rpm with the despa blade. A composition for an aerogel-containing layer was prepared by adding glass wool as a fibrous support to the second mixed solution and sequentially mixing the composition at 30 rpm with the open blade and 1200 rpm with the despa blade. A planetary mixer (D&Tech, PT-005) was included for mixing.

The prepared composition for an aerogel-containing layer was in the form of a slurry, and the composition included 45 wt % aerogel, 45 wt % glass wool, and 10 wt % polyvinyl alcohol based on solid content.

### Manufacturing of Heat Insulation Sheet

The prepared composition for an aerogel-containing layer was applied on a mica sheet (Famica, Muscovite) with a thickness of 0.1 mm as a first base layer, and a mica sheet (Famica, Muscovite) with a thickness of 0.1 mm as a second base layer was stacked on the composition for an aerogel-containing layer and coated using a roll rolling method. Then, a base sheet sequentially stacked in the order of the mica sheet-aerogel-containing layer (thickness: 2 mm)-mica sheet was manufactured by drying the stack at 60° C. for 24 hours.

A composition for a coating layer was prepared by adding a water-dispersible polyurethane-based binder as a binder to ultrapure water as a solvent and mixing the composition with potassium nitrate. A heat insulation sheet in which a coating layer including a polyurethane-based binder and potassium nitrate is formed on the entire outer surface including an upper surface, lower surface, and side surfaces of the base sheet was manufactured by spray-coating the prepared composition for a coating layer on an outermost surface of the base sheet and drying the coating layer at 60° C. for 24 hours.

The composition for a coating layer was in the form of a slurry and included 5 wt % potassium nitrate and 95 wt % water-dispersible polyurethane-based binder based on solid content.

A thickness of the aerogel-containing layer in the manufactured heat insulation sheet was 2 mm, and a thickness of the coating layer was 100 μm.

### Example 2

A base sheet was manufactured in the same manner as in Example 1.

A composition for a coating layer was prepared by adding a water-dispersible polyurethane-based binder as a binder to ultrapure water as a solvent and mixing the binder with potassium nitrate. A heat insulation sheet in which a coating layer including a polyurethane-based binder and potassium nitrate is formed on the entire outer surface including an upper surface, lower surface, and side surfaces of the base sheet was manufactured by spray-coating the prepared composition for a coating layer on an outermost surface of the base sheet and drying the coating layer at 60° C. for 24 hours. The composition for a coating layer was in the form of a slurry and included 15 wt % potassium nitrate and 85 wt % water-dispersible polyurethane-based binder based on solid content. A thickness of the aerogel-containing layer in the manufactured heat insulation sheet was 2 mm, and a thickness of the coating layer was 100 μm.

### Example 3

A heat insulation sheet was manufactured in the same manner as in Example 1, with a difference that in Example 1, instead of the coating layer including 5 wt % potassium nitrate and 95 wt % water-dispersible polyurethane binder, a coating layer including 5 wt % potassium carbonate and 95 wt % water-dispersible polyurethane binder was formed.

### Example 4

A heat insulation sheet was manufactured in the same manner as in Example 1, with a difference that in Example 1, instead of the coating layer including 5 wt % potassium nitrate and 95 wt % water-dispersible polyurethane binder, a coating layer including 5 wt % potassium perchlorate and 95 wt % water-dispersible polyurethane binder was formed.

### Example 5

A heat insulation sheet was manufactured in the same manner as in Example 1, with a difference that in Example 1, the composition for an aerogel-containing layer was changed to 60 wt % aerogel, 25 wt % glass wool, and 15 wt % polyvinyl alcohol based on solid content.

### Example 6

A heat insulation sheet was manufactured in the same manner as in Example 1, with a difference that in Example 1, the composition for an aerogel-containing layer was changed to 65 wt % aerogel, 35 wt % glass wool, and 10 wt % polyvinyl alcohol based on solid content.

### Example 7

A heat insulation sheet was manufactured in the same manner as in Example 1, with a difference that in Example 1, the composition for an aerogel-containing layer was changed to 45 wt % aerogel, 50 wt % glass wool, and 5 wt % polyvinyl alcohol based on solid content.

### Comparative Example 1

A base sheet was manufactured in the same manner as in Example 1. The manufactured base sheet was included as a heat insulation sheet without forming the coating layer.

### Comparative Example 2

A heat insulation sheet was manufactured in the same manner as in Example 1, with a difference that in Example 1, the coating layer was formed with only a water-dispersible polyurethane binder without potassium nitrate.

### Comparative Example 3

A heat insulation sheet was manufactured in the same manner as in Example 1, with a difference that in Example 1, a polyurethane (PU)-based binder was included instead of polyvinyl alcohol in the composition for an aerogel-containing layer.

### Comparative Example 4

A heat insulation sheet was manufactured in the same manner as in Example 1, with a difference that in Example 1, a coating layer including a polyurethane binder and potassium nitrate was formed only on the upper and lower surfaces of the base sheet, and the coating layer was not formed on both side surfaces thereof.

### Comparative Example 5

A heat insulation sheet was manufactured in the same manner as in Example 1, with a difference that in Example 1, a coating layer including a polyurethane binder and potassium nitrate was formed only on both side surfaces of the base sheet, and the coating layer was not formed on the upper and lower surfaces thereof.

### Example 8

A base sheet was manufactured in the same manner as in Example 1. A heat insulation sheet was manufactured by packaging the manufactured base sheet with a fiber-reinforced polymer sheet including 10 wt % potassium nitrate.

### Example 9

A base sheet was manufactured in the same manner as in Example 1. A heat insulation sheet was manufactured by packaging the manufactured base sheet with a high-density polyethylene film including 10 wt % potassium nitrate.

The following physical properties were evaluated for the heat insulation sheets manufactured in Examples and Comparative Examples.

(1) Heat insulation (units: sec): Samples were prepared by cutting the manufactured heat insulation sheet into 232 mm wide and 115 mm wide, each heat insulation sheet sample was placed between a pair of facing 0.5T thick copper plates and placed on a heat press, an upper plate of the heat press was heated to 600° C., and a lower plate of the heat press was maintained at a starting temperature of 40° C. without heating. Then, the time for a temperature of the bottom plate to reach 30 0° C. was measured while applying a pressure of 3500 kgf to the lower plate of the heat press. The longer the measurement time, the better the insulation.

(2) Flame retardancy properties (units: sec): Samples were prepared by cutting the manufactured heat insulation sheet into 50 mm wide and 80 mm wide, a micro torch was installed 5 cm away from the sample, a flame was radiated from the torch for 1 minute, and the torch was removed. Then, whether the heat insulation sheet caught on fire was checked, and if the heat insulation sheet caught on fire, the time it took to extinguish the fire was measured. The shorter the time, the better the flame retardancy effect.

(3) Compression rate (units: %): Samples were manufactured by cutting the manufactured heat insulation sheet into 232 mm wide and 115 mm wide, and a compression rate was measured by setting a zero point, inserting the sample between two 1T thick aluminum plates, and then compressing the sample at a compression speed of 0.02 mm/sec from 0 kN to 80 kN using a UTM device. A higher measurement value indicates a higher compression rate.

TABLE 1

| | | Example | | | | | | | | | Comparative Example | | | | |
|---|---|---|---|---|---|---|---|---|---|---|---|---|---|---|---|
| | | 1 | 2 | 3 | 4 | 5 | 6 | 7 | 8 | 9 | 1 | 2 | 3 | 4 | 5 |
| Base | Aerogel | 45 | 45 | 45 | 45 | 60 | 65 | 45 | 45 | 45 | 45 | 45 | 45 | 45 | 45 |
| sheet | Glass wool | 45 | 45 | 45 | 45 | 25 | 25 | 50 | 45 | 45 | 45 | 45 | 45 | 45 | 45 |
| | PVA | 10 | 10 | 10 | 10 | 15 | 10 | 5 | 10 | 10 | 10 | 10 | 0 | 10 | 10 |
| | Polyurethane- | 0 | 0 | 0 | 0 | 0 | 0 | 0 | 0 | 0 | 0 | 0 | 10 | 0 | 0 |
| | based | | | | | | | | | | | | | | |
| Coating | Potassium | 5 | 15 | 0 | 0 | 5 | 5 | 5 | — | — | — | 0 | 5 | 5 | 5 |
| layer | nitrate | | | | | | | | | | | | | | |
| | Potassium | 0 | 0 | 5 | 0 | 0 | 0 | 0 | — | — | — | 0 | 0 | 0 | 0 |
| | carbonate | | | | | | | | | | | | | | |
| | Potassium | 0 | 0 | 0 | 5 | 0 | 0 | 0 | — | — | — | 0 | 0 | 0 | 0 |
| | perchlorate | | | | | | | | | | | | | | |
| | Binder | 95 | 85 | 95 | 95 | 95 | 95 | 95 | — | — | — | 100 | 95 | 95 | 95 |
| Film or | Potassium | — | — | | — | — | — | — | 10 | 10 | — | — | — | — | — |
| sheet | nitrate | | | | | | | | | | | | | | |

| | | | | | | | | | | | | | | |
|---|---|---|---|---|---|---|---|---|---|---|---|---|---|---|
| Heat insulation | 715 | 703 | 700 | 703 | 760 | 795 | 715 | 715 | 708 | 710 | 680 | 650 | 700 | 695 |
| Flame retardancy | 10 | 3 | 8 | 5 | 12 | 8 | 8 | —* | —* | 23 | 37 | 27 | 20 | 21 |
| Compression rate | 58.0 | 57.6 | 58.3 | 58.6 | 49.0 | 53.0 | 60.1 | 57.0 | 56.0 | 59.0 | 55 | 45 | 58.2 | 58.3 |

*In Table 1, “—” indicates did not catch on fire.

As shown in Table 1, the heat insulation sheets of the Examples had desired or improved heat insulation, flame retardancy, heat propagation delay, and compression properties.

A heat insulation sheet for a rechargeable lithium battery according to one example embodiment can reduce or suppress heat propagation and/or heat transfer in a module by providing desired or improved heat insulation, thereby increasing the safety of the module. In addition, the heat insulation sheet for a rechargeable lithium battery can increase the lifetime of the battery module by providing flame retardancy and heat propagation delay effects. In addition, the heat insulation sheet for a rechargeable lithium battery has desired or improved compression properties, which can reduce the pressure generated by the repeated swelling of a cell during charging and discharging, thereby increasing the stability of the battery.

Although example embodiments of the present disclosure have been described above, the present disclosure is not limited thereto and may be modified in any form within the scope of the claims, the detailed description of the present disclosure, and the accompanying drawings, and that the modifications also fall within the scope of the present disclosure.

What is claimed is:

1. A heat insulation sheet for a rechargeable lithium battery, the heat insulation sheet comprising:
a base sheet including a first base layer and an aerogel-containing layer that are stacked together; and
a member substantially completely surrounding an exterior of the base sheet,
wherein the aerogel-containing layer includes a first binder including a polyvinyl alcohol-based binder, a fibrous support, and an aerogel, and
the member includes one or more of potassium nitrate, potassium carbonate, and potassium perchlorate, and a support.

2. The heat insulation sheet of claim 1, wherein the member is completely in contact with, partially in contact with, or not in contact with the base sheet.

3. The heat insulation sheet of claim 1, wherein the member comprises one of a coating layer, a film, or a sheet.

4. The heat insulation sheet of claim 1, wherein the one or more of potassium nitrate, potassium carbonate, and potassium perchlorate are included in an amount ranging from about 0.1 wt % to about 50 wt % of the member.

5. The heat insulation sheet of claim 1, wherein the support comprises one or more of a second binder and a base resin.

6. The heat insulation sheet of claim 5, wherein the second binder comprises one or more of polyvinyl alcohol, polyethylene glycol, polyacrylamide, polyvinylpyrrolidone, polyurethane, and polyimide.

7. The heat insulation sheet of claim 5, wherein the base resin comprises one or more of a fiber reinforced polymer, high-density polyethylene (HDPE), linear low-density polyethylene (LLDPE), low-density polyethylene (LDPE), polyethylene terephthalate, and polybutylene terephthalate.

8. The heat insulation sheet of claim 1, wherein the member comprises a coating layer including the one or more of potassium nitrate, potassium carbonate, and potassium perchlorate in an amount ranging from about 0.1 wt % to about 50 wt %, and a second binder in an amount ranging from about 50 wt % to about 99.9 wt %.

9. The heat insulation sheet of claim 1, wherein the member comprises a film or sheet including the one or more of potassium nitrate, potassium carbonate, and potassium perchlorate in an amount ranging from about 0.1 wt % to about 50 wt %, and a base resin in an amount ranging from about 50 wt % to about 99.9 wt %.

10. The heat insulation sheet of claim 1, wherein the polyvinyl alcohol-based binder is included in an amount of about 95 wt % or more of the first binder.

11. The heat insulation sheet of claim 1, wherein the fibrous support comprises glass wool.

12. The heat insulation sheet of claim 1, wherein the aerogel-containing layer comprises:
the fibrous support in an amount ranging from about 5 wt % to about 70 wt %,
the aerogel ranging from about 10 wt % to about 90 wt %, and
the polyvinyl alcohol-based binder in an amount ranging from about 0.5 wt % to about 20 wt %.

13. The heat insulation sheet of claim 1, wherein the first base layer comprises a mica sheet.

14. The heat insulation sheet of claim 1, wherein the base sheet further comprises a second base layer.

15. A rechargeable lithium battery module comprising:
a plurality of battery cells that face each other; and
the heat insulation sheet of claim 1 between the plurality of battery cells.
